(19) United States
(12) Patent Application Publication
(10) Pub. No.: US 2023/0260300 A1
(43) Pub. Date: Aug. 17, 2023

(54) VIEW AUGMENTATION USING A DATA PROFILER TO DETECT AND CONVERT CONTENT TO AND/OR FROM A PROFILE-SPECIFIC FORMAT

(71) Applicant: Capital One Services, LLC, McLean, VA (US)

(72) Inventors: Anh TRUONG, Champaign, IL (US); Jeremy GOODSITT, Champaign, IL (US); Austin WALTERS, Savoy, IL (US)

(73) Assignee: Capital One Services, LLC, McLean, VA (US)

(21) Appl. No.: 17/581,192

(22) Filed: Jan. 21, 2022

(51) Int. Cl. G06V 30/14; G06V 30/302; G06V 30/412; G06V 30/246; G06T 19/00

(52) U.S. Cl. CPC G06V 30/1437; G06T 19/006; G06V 30/246; G06V 30/302; G06V 30/412

(57) ABSTRACT

In some embodiments, a profile associated with a user may indicate one or more data types and at least one profile-specific format associated with each of the data types. In response to detecting a document in a camera view, the document may be parsed to identify input fields that correspond to at least one data type of the profile. In response to identifying an input field that requires a format different from a profile-specific format, an input field rendering corresponding to the profile-specific format may be presented on an augmented reality view over the input field. In response to obtaining a user input related to the input field, the input field rendering may be updated in the augmented reality view to depict the user input in the profile-specific format, and the user input in the format required for the input field may be provided to the input field.

### BACKGROUND

Documents with different data formats cause distraction for users because the users may not be familiar with different conventions/templates for those data formats. As one example, people from some countries prefer seeing or writing a person’s name one way (e.g., John Louis Smith), while people from other countries may prefer seeing or writing the name in a different order (e.g., Smith, John Louis). As another example, with respect to dates, some confusion may be caused for users depending on whether the date format [YYYY-DD-MM] or [YYYY-MM-DD] is presented (e.g., especially when the DAY parameter value is between 01 and 12 because the MONTH parameter value will also be between 01 and 12). As a further example, when a user is asked to enter dates into a form that does not utilize the user’s preferred date format, the chance of user error is increased, thereby further negatively impacting the user experience.

### SUMMARY

Methods and systems are described herein for improvements related to view augmentation or document presentation. As one example, methods and systems are described herein for view augmentation by using a data profiler to detect and convert content to and from a profile-specific format or language (e.g., based on one or more profile-specific formats or languages indicated by a profile associated with a user for one or more data types). With respect to conventional websites with a user-fillable form, for example, a recipient system (for which the completed form is intended to be transmitted) is typically configured to process input values of input fields in a manner that requires the input values to be received in certain formats or languages. As indicated above, in one scenario, where a form requires the format [YYYY-DD-MM] for dates, a user input in the format [YYYY-MM-DD] may cause the recipient system to produce a result with an error (e.g., storing or processing of the wrong date).

In another scenario, although conventional augmented reality systems may automatically translate all text (including text of a user-fillable form) presented on a website to text in a language specified by the user, the recipient system may not be configured to process any user input that is in the user-specified language. As such, even if the user can read and understand the translated text, the recipient system may still require the user to provide user input in the original language utilized by the form or its input fields.

In some embodiments, with respect to the augmented reality context, in response to detecting a web document in a camera view, a head-mounted device may parse the web document to identify user-fillable fields of the web document that correspond to at least one data field type of a user profile associated with a user. In response to identifying a user-fillable field that uses a field type format or language different from a user-specific format or language (e.g., associated with a data field type of the user profile), the head-mounted device may cause an input field rendering corresponding to the user-specific format or language to be presented in an augmented reality view over the user-fillable field. In one use case, for example, if a date field requires the format YYYY-DD-MM (and the user profile indicates that the user prefers the format YYYY-MM-DD), the input field rendering may depict a modified date field along with a suggestion that the format YYYY-MM-DD may be used to provide the date for the date field. In this way, for example, the system (including the head-mounted device) may decrease the chance of user error by aligning the modification shown in the augmented reality view with the user-specific format.

In some embodiments, after the input field rendering is presented and a user input related to the user-fillable field is obtained, the head-mounted device may update the input field rendering in the augmented reality view to depict the user input in the user-specific format or language. The head-mounted device may also transform the user input into the field type format or language required for the user-fillable field and provide the transformed user input to the user-fillable field. In response to a user submission of the form (including the user-fillable field), the transformed user input may be transmitted as a value for the user-fillable field to a recipient of the form. Thus, even though the user is enabled to enter the user input in the user-specific format or language (e.g., the format YYYY-MM-DD), the input value transmitted to the recipient is in the field type format or language required for the user-fillable field (e.g., the format YYYY-DD-MM), thereby avoiding issues related to the technical configuration of the recipient system.

Various other aspects, features, and advantages of the invention will be apparent through the detailed description of the invention and the drawings attached hereto. It is also to be understood that both the foregoing general description and the following detailed description are examples and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 shows a system for facilitating view augmentation, in accordance with one or more embodiments.

FIGS. 2A-2B show an augmented reality use case with a head-mounted device, in accordance with one or more embodiments.

FIGS. 3A-3B show depictions of a document and a modified view of the document presentation on the same user device with respect to a profile-specific date format, in accordance with one or more embodiments.

FIGS. 3C-3D show depictions of a document and a modified view of the document presentation on the same user device with respect to a profile-specific name format, in accordance with one or more embodiments.

FIG. 4 shows a machine learning model configured to facilitate view augmentation, in accordance with one or more embodiments.

FIG. 5 shows a flowchart of a method of facilitating view augmentation, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

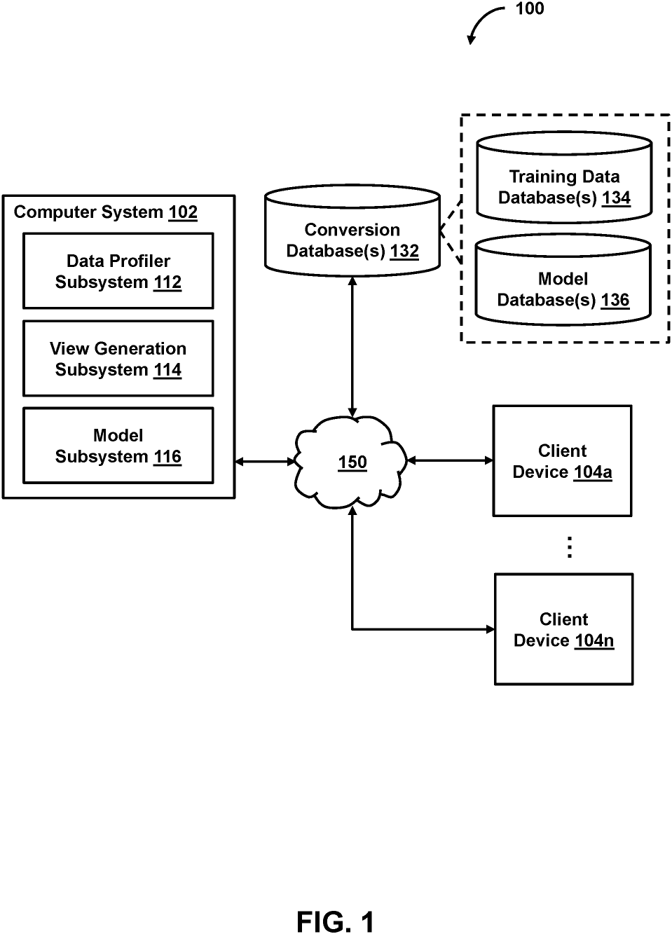

FIG. 1 shows a system 100 for facilitating view augmentation, in accordance with one or more embodiments. As shown in FIG. 1, system 100 may include computer system 102, client device 104 (or client devices 104a-104n), or other components. Computer system 102 may include data profiler subsystem 112, view generation subsystem 114, model subsystem 116, or other components. Each client device 104 may include any type of mobile terminal, fixed terminal, or other device. By way of example, client device 104 may include a desktop computer, a notebook computer, a tablet computer, a smartphone, a wearable device, or other client device. Users may, for instance, utilize one or more client devices 104 to interact with one another, one or more servers, or other components of system 100. It should be noted that, while one or more operations are described herein as being performed by particular components of computer system 102, those operations may, in some embodiments, be performed by other components of computer system 102 or other components of system 100. As an example, while one or more operations are described herein as being performed by components of computer system 102, those operations may, in some embodiments, be performed by components of client device 104. It should be noted that, although some embodiments are described herein with respect to machine learning models, other prediction models (e.g., statistical models or other analytics models) may be used in lieu of or in addition to machine learning models in other embodiments (e.g., a statistical model replacing a machine learning model and a non-statistical model replacing a non-machine-learning model in one or more embodiments).

In some embodiments, system 100 may use a data profile to identify one or more portions of a content item (e.g., a document portion that corresponds to at least one data type of the data profile) and generate a modified view that includes one or more modified versions of the content item portions in the respective data formats or languages indicated by the data profile. As an example, the data profile may indicate one or more formats; one or more languages; one or more data types with which a respective format or language of the profile is associated; one or more demographics, locations, or other user attributes with which a respective format or language of the profile is associated; or other information. In one use case, each data profile may be associated with a user, and the respective data profile associated with the user may be used to identify portions of the content item and generate the modified view for the user. A portion of the content item may be identified, for example, based on a determination that the identified portion (i) matches at least one data type of the data profile, (ii) utilizes a format or language different from a user-specific format or language of the data profile for the matching data type, or (iii) satisfies one or more other criteria.

As another example, the modified view may include an augmented reality view or other modified presentation of the content item. In one scenario, with respect to the augmented reality view, a modified portion (corresponding to the profile-specific format or language) may be overlaid over a corresponding position of the respective original portion in the augmented reality view. In another scenario, the original portion may be defined as a hidden portion in the modified view, and the modified portion may be placed over the corresponding position of the original portion, thereby visually replacing the original portion in the modified view. In this way, for example, system 100 may decrease the chance of user error or otherwise improve the user experience by aligning the modification shown in the modified view with the profile-specific format (e.g., specific to a user associated with the profile, specific to a demographic, location, or other user attribute associated with the profile, etc.).

In some embodiments, system 100 may use a data profile to identify one or more input fields of a document (e.g., that correspond to at least one data type of the data profile) and generate a modified view that includes one or more modified versions of the input fields (or modified input fields) in the respective data formats or languages indicated by the data profile. As an example, in response to access of the document by a user, the data profile may be used to identify an input field of the document and generate a modified view for the user. The input field of the document may be identified, for example, based on a determination that the identified input (i) matches at least one data type of the data profile, (ii) utilizes a format or language different from the profile-specific format or language of the data profile for the matching data type, or (iii) satisfies one or more other criteria. In some embodiments, after obtaining a user input related to the input field, system 100 may update the modified input field (e.g., to depict the user input in the profile-specific format or language), transform the user input into the format or language required for the input field, and provide the transformed user input to the input field. As such, even though the user is enabled to enter the user input in the profile-specific format or language, system 100 may avoid any issues associated with providing the document with data in a format or language that is inconsistent with one or more document requirements. As an example, in response to a user submission of a form (including the input field), the transformed user input may be transmitted as a value for the input field to a recipient of the form. Thus, despite the user entering the user input in the profile-specific format or language, the input value transmitted to the recipient is in the format or language required for the input field, thereby avoiding issues related to the technical configuration of the recipient system.

### Subsystems 112-116

In some embodiments, data profiler subsystem 112 may obtain a profile associated with a user or a user attribute of the user. As an example, the profile may indicate one or more formats; one or more languages; one or more data types with which a respective format or language of the profile is associated; one or more demographics, locations (e.g., country, state, zip code, etc.), or other user attributes with which a respective format or language of the profile is associated; or other information. In one use case, the profile may specify that the user prefers (i) the format [YYYY-MM-DD] (e.g., 2000-01-31) for user input fields corresponding to dates, (ii) the format [Month DD, YYYY] (e.g., Jan. 31, 2000) for non-user-input portions (e.g., portions intended for reading or listening as opposed to user-fillable fields), (iii) the format “[First Name] [Middle Name] [Family Name]” for user input fields or non-user-input portions corresponding to names, (iv) Simplified Chinese for instructions related to user input fields, or (v) other formats associated with other data types.

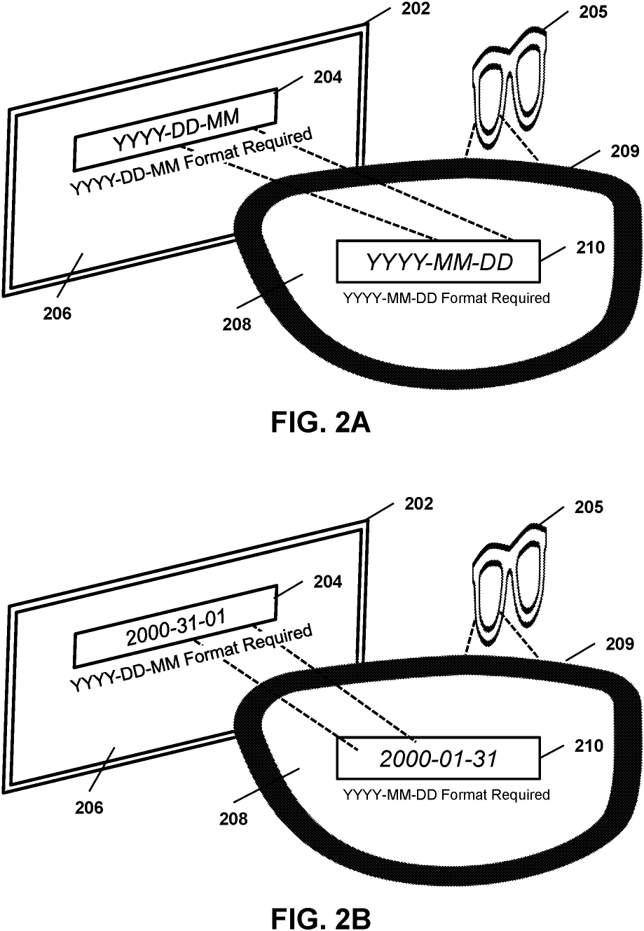

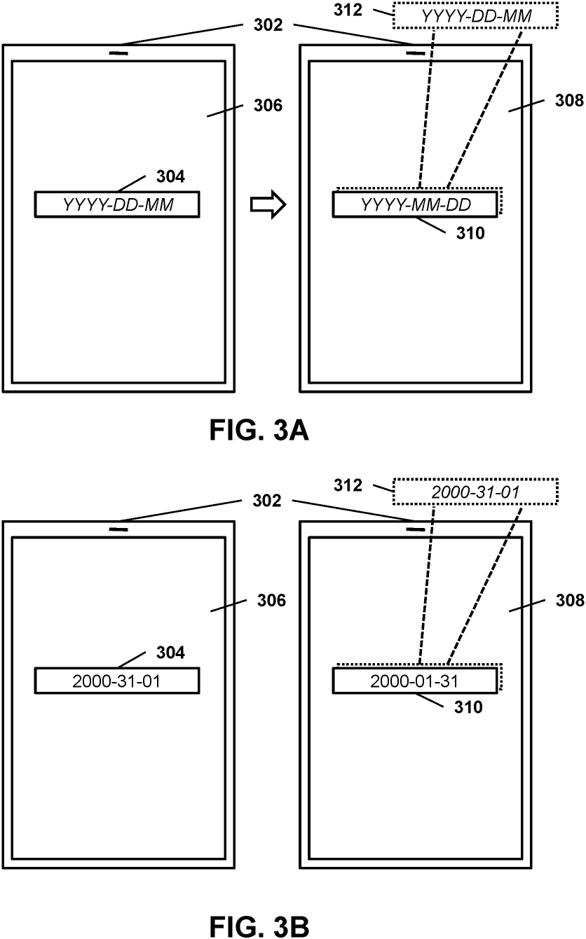

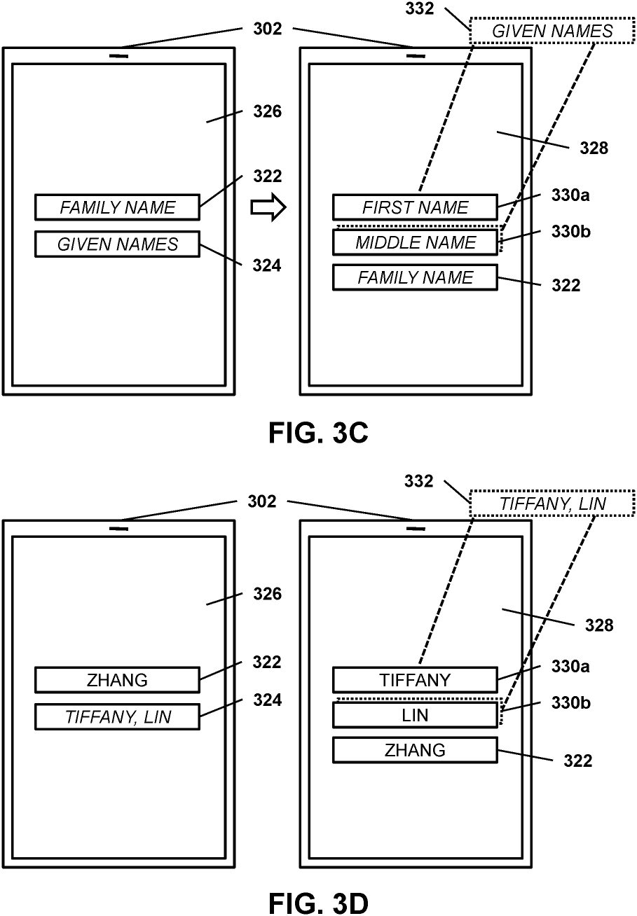

In some embodiments, data profiler subsystem 112 may determine one or more portions of a document or other content item. As an example, the document may be parsed based on the profile to determine one or more portions (e.g., input fields or other portions corresponding to data types of the profile) that require a format different from the respective profile-specific format. For example, an input field may correspond to a data type of the profile, and the input field may be identified as an item of interest in the document in response to a determination that the input field has a format or language different from the profile-specific format or language associated with the same data type. It should be noted that, while examples of such document/content item described herein include a webpage, other examples of such document/content item may include other electronic documents (e.g., a document presented on a word processing application, a spreadsheet presented on a spreadsheet application, an email presented on an email application, an image depicting text or other content, etc.) or other content items (e.g., physical documents, text or other content depicted on a physical object, etc.). As an example, the respective webpages described with respect to use cases, scenarios, or examples corresponding to FIGS. 2A-2B and 3A-3D may instead be such other electronic documents or other content items in other examples.

In one scenario, with respect to FIG. 2A, a user interface on user device 202 may present a form on a webpage that includes a date input field and its related instruction based on the format [YYYY-DD-MM]. If a profile associated with a user of user device 202 (e.g., a television, tablet, or other device) and head-mounted device 205 specifies that the user prefers the format [YYYY-MM-DD] (e.g., 2000-01-31) for user input fields corresponding to dates, the head-amounted device 205 may identify the date input field of the webpage based on a determination that the date input field has a format different from the user-specific format [YYYY-MM-DD] of the profile (e.g., a determination by the head-mounted device 205 or a computer system in communication with the head-mounted device 205, such as computer system 102).

In some embodiments, based on identification of one or more portions of a document or other content item, view generation subsystem 114 may generate a modified view that includes one or more modified portions corresponding to the identified portions (e.g., modified portions that are in a profile-specific format or language of a profile associated with a user). In some embodiments, in response to a portion of a document being identified (e.g., as a document portion that uses a format or language different from the profile-specific format or language associated with the same data type), a respective modified portion corresponding to the profile-specific format may be presented in the modified view over the identified portion. As an example, the modified portion may visually replace the identified portion in the modified view. In one use case, the identified portion may be defined as a hidden portion in the modified view such that the identified portion is not displayed in the modified view. For example, where the identified portion is an input field, the INPUT TYPE attribute of the INPUT element may be defined as “hidden.” In another use case, the modified portion may be overlaid over the identified portion in the modified view. For example, the modified view may be an augmented reality view, and the modified input field may be an input field rendering that is placed in the augmented reality view over the input field in a live image captured by a camera of a user device of the user.

In one scenario, with respect to FIG. 2A, based on the date input field 204 (of a webpage 206 presented on user device 202) being identified as requiring a format different from the user-specific format [YYYY-MM-DD] of a profile associated with the user, the augmented reality view 208 (presented on the display 209 of head-mounted device 205) may be generated to include a rendering of modified date input field 210 (e.g., a modified version of the original date input field 204). As an example, the modified date input field 210 allows the format [YYYY-MM-DD] (e.g., as compared to the format [YYYY-DD-MM] accepted by the original input field). As another example, the instructions related to the modified date input field 210 also reflect the format [YYYY-MM-DD] (e.g., as compared to the format [YYYY-DD-MM] reflected by the instructions related to the original date input field 204). As a further example, the rendering of the modified date input field 210 (and its related instructions) may be placed in the augmented reality view 208 over the date input field 204 in a live video stream captured by a camera of the head-mounted device 205 (e.g., by overlaying the input field rendering over a position of the input field in the live video stream as part of the augmented reality view 208).

In another scenario, with respect to FIG. 3A, based on the date input field 304 (of a webpage 306 presented on user device 302) being identified as using a format different from the user-specific format [YYYY-MM-DD] of a profile associated with the user, the modified view 308 may be generated to include the modified date input field 310. As an example, the modified date input field 310 allows the format [YYYY-MM-DD] (e.g., as compared to the format [YYYY-DD-MM] accepted by the original date input field 304). As another example, the modified view may include a modified version of the webpage 306 and may define the date input field 304 as a hidden input field, thereby causing the date input field 304 not to be visually presented on the modified view 308 (see FIG. 3B, where the date input field 304 is represented as a hidden object 312).

In a further scenario, with respect to FIG. 3C, based on the portion (e.g., name input fields 322 and 324) of a webpage 326 presented on user device 302 being identified as using a format different from the user-specific format “[First Name] [Middle Name] [Family Name]” of a profile associated with the user, the modified view 328 may be generated to include a modified portion (e.g., name input field 322 and modified name input fields 330a and 330b). As an example, the name input fields 322, 330a, and 330b of the modified portion allow the format “[First Name] [Middle Name] [Family Name]” (e.g., as compared to the format “[Family Name] [Given Names]” accepted by the original name input fields 322 and 324). As another example, the modified view may include a modified version of the webpage 326 and may define the name input field 324 as a hidden input field, thereby causing the name input field 324 not to be visually presented on the modified view 328 (see FIG. 3D, where the name input field 324 is represented as a hidden object 332).

In another scenario, a user may be drafting a document in a word processing application, and the user may specify one or more expected data formats of a subsequent version of the document (e.g., by specifying the expected data formats for one or more data types in a profile associated with the user). Although the word processing application may present portions of the document corresponding to the respective data types in their original formats (e.g., as manually inputted by the user) while the user is editing the document, the word processing application (or another application or subsystem) may generate a modified view of the document that depicts the portions of the document corresponding to the respective data types in the expected data formats (e.g., modified document portions in the profile-specific formats). As an example, the modified view may be a modified version of the document, and the modified document may include the modified portions in lieu of the original portions of the document. As another example, the modified view may be a modified version of the document with metadata that defines how the respective portions of the document will be presented when accessed by the user or when accessed by one or more other users (e.g., by defining conditional display attributes for each of the respective portions). As a further scenario, when the modified document is opened by the user, the presentation of the modified document may include depictions of the original portions (e.g., the date format [YYYY-MM-DD] originally inputted by the user). On the other hand, when the modified document is opened by another user, the presentation of the modified document may include depictions of the modified portions (e.g., the profile-specific date format [YYYY-DD-MM] that may be expected by other users) in lieu of the original portions.

In some embodiments, in response to an input field of a document being identified (e.g., as a document portion that uses a format or language different from the profile-specific format or language associated with the same data type), view generation subsystem 114 may cause a respective modified input field corresponding to the profile-specific format to be presented in a modified view. Subsequent to obtaining a user input related to the input field, view generation subsystem 114 may update the modified input field. As an example, the modified input field may be updated to depict the user input in the profile-specific format or language (e.g., associated with the data type of both the input field and the profile). In one scenario, where the user input provided by the user is already in the profile-specific format or language, the user input may be provided to and presented in the modified input field. In another scenario, where the user input provided by the user is initially not in the profile-specific format or language, the user input may be transformed into the profile-specific format or language, and the transformed user input may be presented in the modified input field.

In some embodiments, view generation subsystem 114 may provide the user input in the format or language for the input field to the input field (e.g., while the modified input field is presented in the modified view). As an example, the user input may be provided by the user in the profile-specific format or language and presented in the modified input field. In connection with presenting the modified input field, the user input may be transformed into the format or language for the input field, and the transformed user input may be provided to the input field. As an example, the foregoing transformation(s) may be performed via one or more language or other prediction models. In one scenario, a translation system might generate multiple translations of the same target data, and the language models score all the translations to pick the one that is most likely. In another scenario, the prediction models may include one or more nonlinear neural network models (e.g., recurrent neural networks (RNN) or other neural networks). Such models may, for example, be trained on a large corpus of data in connection with novel training algorithms (e.g., attention networks, BERT, etc.).

In one use case, with respect to FIG. 2B, after obtaining a user input “2001-01-31,” the rendering of the modified date input field 210 may be updated to include the user input “2001-01-31” input in the profile-specific format [YYYY-MM-DD] of the profile associated with the user. While the modified date input field 210 is presented on the augmented reality view 208, the user input “2001-01-31” may be transformed into the format [YYYY-DD-MM] required for the date input field 204, and the transformed input (e.g., “2001-31-01”) may be provided to the date input field 204. For example, the webpage 206 presented on user device 202 may include an embedded application that communicates with an augmented reality application executing on the head-mounted device 205, and the augmented reality application may transmit the transformed input to the date input field 204 via the embedded application (or a cloud-based service associated with the embedded application). As another example, the augmented reality view 208 may include a modified version of the webpage 206 and may define the date input field 204 as a hidden input field (e.g., thereby causing the date input field 204 not to be visually presented on the augmented reality view 208), and an augmented reality application presenting the augmented reality view 208 may provide the transformed user input to the date input field 204 defined on the modified webpage.

In another use case, with respect to FIG. 3B, after obtaining a user input “2001-01-31,” the modified date input field 310 may be updated to include the user input “2001-01-31” input in the profile-specific format [YYYY-MM-DD] of the profile associated with the user. While the modified date input field 210 is presented on the modified view 308, the user input “2001-01-31” may be transformed into the format [YYYY-DD-MM] required for the date input field 304, and the transformed input (e.g., “2001-31-01”) may be provided to the date input field 304. For example, the modified view 308 may include a modified version of the webpage 306 and may define the date input field 304 as a hidden input field (e.g., where the date input field 304 is represented as a hidden object 312), and a user application presenting the modified view 308 may provide the transformed user input to the date input field 304 defined on the modified webpage (e.g., by providing the transformed user input to the hidden object 312).

In a further use case, with respect to FIG. 3D, after obtaining the user input(s) “Tiffany,” “Lin,” and “Zhang,” the name input fields 330a, 330b, and 322 on the modified view 328 may be updated to include “Tiffany,” “Lin,” and “Zhang,” respectively. While the modified portion (e.g., the name input fields 330a, 330b, and 322) is presented on the modified view 308, the user input(s) “Tiffany” and “Lin” may be transformed into the format required for the original name input field 324, and the transformed input (e.g., “Tiffany, Lin”) may be provided to the name input field 324. For example, the modified view 328 may include a modified version of the webpage 326 and may define the name input field 324 as a hidden input field (e.g., where the name input field 324 is represented as a hidden object 332), and a user application presenting the modified view 328 may provide the transformed user input to the name input field 324 defined on the modified webpage (e.g., by providing the transformed user input to the hidden object 332).

In some use cases, with respect to FIGS. 2B, 3B, and 3D, a recipient system that will process the respective completed form may be configured to process input values of input fields in a manner that requires the input values to be received in the original form formats. For example, where a form requires the format [YYYY-DD-MM] for dates, a user input in the format [YYYY-MM-DD] may cause the recipient system to produce a result with an error (e.g., storing or processing of the wrong date). To overcome the foregoing issues related to the technical configuration of the recipient system, for example, even though the user is enabled to enter and see a user input in a profile-specific format different from a format required by the corresponding user input field, the user input may be transformed into the required format, and the transformed user input in the foregoing use cases (described with respect to FIGS. 2B, 3B, and 3D above) may be transmitted as a value for the corresponding input field to the recipient system.

In some embodiments, in response to a first portion of a document being identified as a first document portion that uses a format different from a profile-specific format (e.g., associated with the same data type as the first document portion), a first modified portion corresponding to the profile-specific format may be presented in a modified view over the identified first portion. Moreover, in response to a second portion of the document being identified as a second document portion that uses a language different from a profile-specific language (e.g., associated with the same data type as the second document portion), a second modified portion corresponding to the profile-specific language may be presented in the modified view over the identified second portion. As an example, the first and second modified portions may visually replace the identified first and second portions in the modified view, respectively.

In one use case, a profile associated with a user may specify that the user prefers (i) the format [YYYY-MM-DD] (e.g., 2000-01-31) for user input fields corresponding to dates, (ii) the format [Month DD, YYYY] (e.g., Jan. 31, 2000) for non-user-input portions (e.g., portions intended for reading or listening as opposed to user-fillable fields), and (iii) Simplified Chinese for instructions related to user input fields. As such, where a webpage includes a date input field in the format [YYYY-DD-MM] and its related instructions in American English, then both the date input field and its related instructions may be identified as matching the two data types in the profile. In response to such identification, a modified version of the webpage may be generated to include a modified date input field that accepts the format [YYYY-MM-DD] and the modified related instruction in Simplified Chinese.

In another use case, a profile associated with a user may specify that the user prefers (i) the format [YYYY-MM-DD] for user input fields corresponding to dates, (ii) American English for user input fields corresponding to names and addresses, and (iii) Simplified Chinese for user input fields corresponding to “Comments.” Thus, where a webpage includes a date input field in the format [YYYY-DD-MM] and a “Comments” input field in American English, then both the date input field and the “Comments” input field may be identified as matching the two data types in the profile. In response to such identification, a modified version of the webpage may be generated to include a modified date input field that accepts the format [YYYY-MM-DD] and a modified “Comments” input field that accepts the Simplified Chinese language.

In some embodiments, model subsystem 116 may train or configure one or more language or other prediction models to facilitate one or more embodiments described herein. In some embodiments, such models may be used to perform data format detection and conversion, speech recognition, word space mapping, or language translation. As an example, such models may be trained or configured to perform the foregoing functions by respectively mutually mapping input data and output data in nonlinear relationships based on learning (e.g., deep learning).

In some embodiments, the prediction models may include one or more neural networks or other machine learning models. As an example, neural networks may be based on a large collection of neural units (or artificial neurons). Neural networks may loosely mimic the manner in which a biological brain works (e.g., via large clusters of biological neurons connected by axons). Each neural unit of a neural network may be connected with many other neural units of the neural network. Such connections can be enforcing or inhibitory in their effect on the activation state of connected neural units. In some embodiments, each individual neural unit may have a summation function that combines the values of all its inputs together. In some embodiments, each connection (or the neural unit itself) may have a threshold function such that the signal must surpass the threshold before it propagates to other neural units. These neural network systems may be self-learning and trained, rather than explicitly programmed, and can perform significantly better in certain areas of problem solving, as compared to traditional computer programs. In some embodiments, neural networks may include multiple layers (e.g., where a signal path traverses from front layers to back layers). In some embodiments, backpropagation techniques may be utilized by the neural networks, where forward stimulation is used to reset weights on the “front” neural units. In some embodiments, stimulation and inhibition for neural networks may be more free-flowing, with connections interacting in a more chaotic and complex fashion.

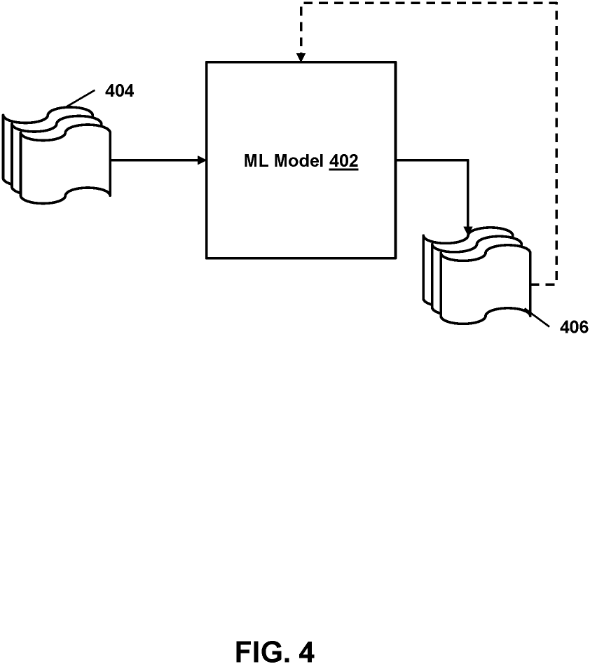

As an example, with respect to FIG. 4, machine learning model 402 may take inputs 404 and provide outputs 406. In one use case, outputs 406 may be fed back to machine learning model 402 as input to train machine learning model 402 (e.g., alone or in conjunction with user indications of the accuracy of outputs 406, with labels associated with the inputs, or with other reference feedback information). In another use case, machine learning model 402 may update its configurations (e.g., weights, biases, or other parameters) based on its assessment of its prediction (e.g., outputs 406) and reference feedback information (e.g., user indication of accuracy, reference labels, or other information). In another use case, where machine learning model 402 is a neural network, connection weights may be adjusted to reconcile differences between the neural network’s prediction and the reference feedback. In a further use case, one or more neurons (or nodes) of the neural network may require that their respective errors be sent backward through the neural network to them to facilitate the update process (e.g., backpropagation of error). Updates to the connection weights may, for example, be reflective of the magnitude of error propagated backward after a forward pass has been completed. In this way, for example, the machine learning model 402 may be trained to generate better predictions.

As an example, where the prediction models include a neural network, the neural network may include one or more input layers, hidden layers, and output layers. The input and output layers may respectively include one or more nodes, and the hidden layers may each include a plurality of nodes. When an overall neural network includes multiple portions trained for different objectives, there may or may not be input layers or output layers between the different portions. The neural network may also include different input layers to receive various input data. Also, in differing examples, data may be input to the input layer in various forms, and in various dimensional forms, input to respective nodes of the input layer of the neural network. In the neural network, nodes of layers other than the output layer are connected to nodes of a subsequent layer through links for transmitting output signals or information from the current layer to the subsequent layer, for example. The number of the links may correspond to the number of the nodes included in the subsequent layer. For example, in adjacent fully connected layers, each node of a current layer may have a respective link to each node of the subsequent layer, noting that in some examples such full connections may later be pruned or minimized during training or optimization. In a recurrent structure, a node of a layer may be again input to the same node or layer at a subsequent time, while in a bidirectional structure, forward and backward connections may be provided. The links are also referred to as connections or connection weights, as referring to the hardware-implemented connections or the corresponding “connection weights” provided by those connections of the neural network. During training and implementation, such connections and connection weights may be selectively implemented, removed, and varied to generate or obtain a resultant neural network that is thereby trained and that may be correspondingly implemented for the trained objective, such as for any of the above example recognition objectives.

### Example Flowcharts

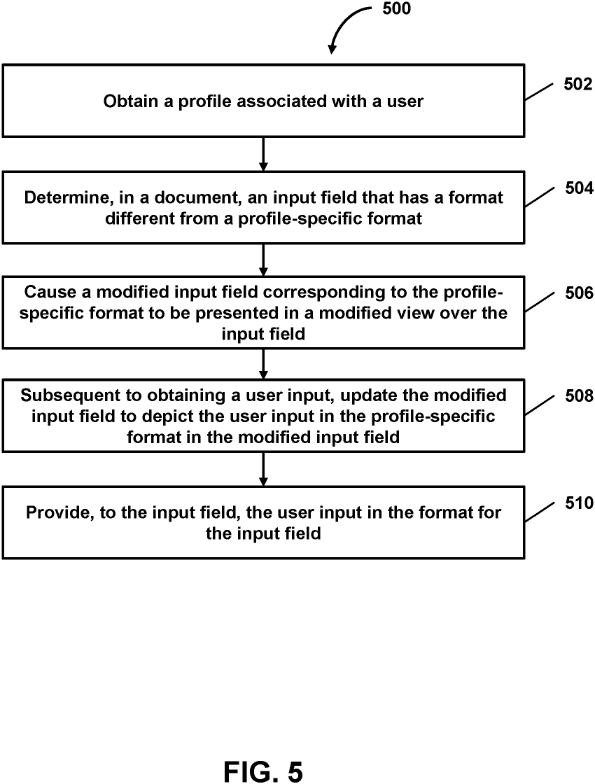

FIG. 5 is an example flowchart of processing operations of a method 500 that enable the various features and functionality of the system as described in detail above. The processing operations of the method presented below are intended to be illustrative and non-limiting. In some embodiments, for example, the method may be accomplished with one or more additional operations not described and/or without one or more of the operations discussed. Additionally, the order in which the processing operations of the method are illustrated (and described below) is not intended to be limiting.

In some embodiments, the method may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on an electronic storage medium. The processing devices may include one or more devices configured through hardware, firmware, and/or software to be specifically designed for execution of one or more of the operations of the methods.

In an operation 502, a profile may be obtained. As an example, the profile may be associated with a user. As another example, the profile may indicate one or more data types, at least one profile-specific format associated with each of the data types, or other information. Operation 502 may be performed by a subsystem that is the same as or similar to data profiler subsystem 112, in accordance with one or more embodiments.

In an operation 504, one or more input fields of a document may be determined. As an example, the document may be parsed based on the profile to determine one or more input fields that require a format different from the respective profile-specific format. As an example, an input field may correspond to a data type of the profile, and the input field may be identified as an item of interest in the document in response to the input field having a format different from the profile-specific format associated with the same data type. Operation 504 may be performed by a subsystem that is the same as or similar to data profiler subsystem 112, in accordance with one or more embodiments.

In an operation 506, a modified input field corresponding to the profile-specific format may be presented in a modified view over the input field of the document. As an example, the modified input field may visually replace the input field in the modified view. In one use case, the input field may be defined as a hidden input field in the modified view such that the input field is not displayed in the modified view (e.g., by marking the INPUT TYPE attribute of the INPUT element as “hidden”). In another use case, the modified input field may be overlaid over the input field in the modified view. For example, the modified view may be an augmented reality view, and the modified input field may be an input field rendering that is placed in the augmented reality view over the input field in a live image (e.g., a live video stream) captured by a camera of a user device of the user (e.g., a head-mounted device or other user device of the user). Operation 506 may be performed by a subsystem that is the same as or similar to view generation subsystem 114, in accordance with one or more embodiments.

In an operation 508, subsequent to obtaining a user input related to the input field, the modified input field may be updated. As an example, the modified input field may be updated to depict the user input in the profile-specific format (e.g., associated with the data type of both the input field and the profile). In one scenario, where the user input provided by the user is already in the profile-specific format, the user input may be provided to and presented in the modified input field. In another scenario, where the user input provided by the user is initially not in the profile-specific format, the user input may be transformed into the profile-specific format, and the transformed user input may be presented in the modified input field. Operation 508 may be performed by a subsystem that is the same as or similar to view generation subsystem 114, in accordance with one or more embodiments.

In an operation 510, the user input may be provided in the format for the input field to the input field (e.g., while the modified input field is presented in the modified view). As an example, the user input may be provided by the user in the profile-specific format and presented in the modified input field. In connection with presenting the modified input field, the user input may be transformed into the format for the input field, and the transformed user input may be provided to the input field. In some embodiments, the modified view may include the input field and the modified input field as part of a form. In response to a user submission of the form, the user input may be transmitted in the format required for the input field (e.g., as a value for the input field) to a recipient associated with the form. As an example, despite the user submission of the form, the user input is not transmitted in the profile-specific format to the recipient of the form. Operation 510 may be performed by a subsystem that is the same as or similar to view generation subsystem 114, in accordance with one or more embodiments.

In some embodiments, the various computers and subsystems illustrated in FIG. 1 may include one or more computing devices that are programmed to perform the functions described herein. The computing devices may include one or more electronic storages (e.g., conversion database(s) 132, which may include training data database(s) 134, model database(s) 136, etc., or other electronic storages), one or more physical processors programmed with one or more computer program instructions, and/or other components. The computing devices may include communication lines or ports to enable the exchange of information within a network (e.g., network 150) or other computing platforms via wired or wireless techniques (e.g., Ethernet, fiber optics, coaxial cable, WiFi, Bluetooth, near-field communication, or other technologies). The computing devices may include a plurality of hardware, software, and/or firmware components operating together. For example, the computing devices may be implemented by a cloud of computing platforms operating together as the computing devices.

The electronic storages may include non-transitory storage media that electronically stores information. The storage media of the electronic storages may include one or both of (i) system storage that is provided integrally (e.g., that is substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent processing functionality of a plurality of devices operating in coordination. The processors may be programmed to execute computer program instructions to perform functions described herein of subsystems 112-116 or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems 112-116 described herein is for illustrative purposes and is not intended to be limiting, because any of subsystems 112-116 may provide more or less functionality than is described. For example, one or more of subsystems 112-116 may be eliminated, and some or all of its or their functionality may be provided by other subsystems of subsystems 112-116. As another example, additional subsystems may be programmed to perform some or all of the functionality attributed herein to one of subsystems 112-116.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The present techniques will be better understood with reference to the following enumerated embodiments:

1. A method comprising: obtaining a profile indicating one or more data types and at least one profile-specific format or language (e.g., associated with each data type of the data types); determining a portion of a content item that is in a format different from a profile-specific format or language (e.g., associated with a data type to which the portion corresponds); and causing a modified portion corresponding to the profile-specific format or language to be presented in a modified view (e.g., over the portion of the content item).

2. The method of the preceding embodiment, further comprising: obtaining a user input (e.g., in the profile-specific format); updating the modified portion such that the modified portion depicts the user input in the profile-specific format or language; providing, to the portion, the user input in the format or language of the portion (e.g., while the modified portion corresponding to the profile-specific format or language is presented in the modified view).

3. The method of the preceding embodiment, further comprising: transforming the user input into the format or language of the portion, wherein providing the user input comprises providing the transformed user input to the portion (e.g., while the modified portion corresponding to the profile-specific format or language is presented in the modified view).

4. The method of any of the preceding embodiments, wherein the modified portion visually replaces the portion in the modified view.

5. The method of any of the preceding embodiments, further comprising: defining the portion as a hidden portion in the modified view in connection with causing the modified portion to be presented in the modified view.

6. The method of any of the preceding embodiments, wherein the modified view comprises the portion and the modified portion as part of a form, the method further comprising: in response to a user submission of the form, transmitting, to a recipient associated with the form, the user input in the format or language of the portion as a value for the portion (e.g., without transmitting the user input in the profile-specific format or language to the recipient).

7. The method of any of the preceding embodiments, further comprising: determining, based on the profile, a second portion of the content item that corresponds to a language different from a profile-specific language of the profile; causing a second modified portion corresponding to the profile-specific language to be presented in the modified view over the second portion of the content item; subsequent to obtaining a second user input in the profile-specific language, updating the second modified portion such that the second modified portion depicts the second user input in the profile-specific language of the profile; and providing, to the second portion, the second user input in the language to which the second portion corresponds while the second modified portion corresponding to the profile-specific language is presented in the modified view.

8. The method of the preceding embodiment, wherein the modified view comprises, as part of a form, the portion, the modified portion, the second portion, and the second modified portion, the method further comprising: in response to a user submission of the form, transmitting, to a recipient associated with the form, (i) the user input in the format or language of the portion as a value for the portion and (ii) the second user input in the language to which the second portion corresponds, without transmitting the user input in the profile-specific format or language to the recipient and without transmitting the second user input in the profile-specific language to the recipient.

9. The method of any of the preceding embodiments 7-8, the operations further comprising: defining the second portion as a hidden portion in the modified view in connection with causing the modified portion to be presented in the modified view such that the modified portion visually replaces the portion in the modified view.

10. The method of any of the preceding embodiments, wherein the modified view comprises an augmented reality view.

11. The method of any of the preceding embodiments, wherein the profile is associated with a user, and the determination of the portion of the content item or the presentation of the modified portion in the modified review is performed in response to detecting the user accessing the content item (e.g., detecting the user’s device accessing content of a document, detecting content in a camera of the user’s device, etc.).

12. The method of any of the preceding embodiments, wherein the portion is a text portion of the content item, and the modified portion is a modified text portion of the content item.

13. The method of any of the preceding embodiments, wherein the portion is an input field of the content item, and the modified portion is a modified input field of the content item.

14. A tangible, non-transitory, machine-readable medium storing instructions that, when executed by a data processing apparatus, cause the data processing apparatus to perform operations comprising those of any of the foregoing method embodiments.

15. A system comprising: one or more processors; and memory storing instructions that, when executed by the processors, cause the processors to effectuate operations comprising those of any of the foregoing method embodiments.

What is claimed is:

1. A head-mounted device for providing augmented reality rendering of content in a user-specific data format to enhance a web document region corresponding to a different data format, the head-mounted device comprising:
one or more processors programmed with computer program instructions that, when executed, cause operations comprising:
in response to detecting a web document in a camera view, parsing the web document to identify user-fillable fields of the web document that correspond to at least one data field type of a user profile associated with a user, the user profile indicating multiple data field types and at least one user-specific format associated with each data field type of the multiple data field types;
in response to identifying a user-fillable field that requires a field type format different from a user-specific format associated with a data field type of the user profile, causing an input field rendering corresponding to the user-specific format to be presented in an augmented reality view over the user-fillable field, wherein the user-fillable field corresponds to the data field type of the user profile;
in response to obtaining a user input related to the user-fillable field, updating the input field rendering in the augmented reality view to depict the user input in the user-specific format associated with the data field type as part of the input field rendering; and
providing, to the user-fillable field, the user input in the field type format required for the user-fillable field while the updated input field rendering is presented in the augmented reality view over the user-fillable field.

2. The head-mounted device of claim 1, the operations further comprising:
transforming the user input into the field type format required for the user-fillable field,
wherein providing the user input comprises providing the transformed user input to the user-fillable field while the updated input field rendering is presented in the augmented reality view over the user-fillable field.

3. A method comprising:
obtaining a profile associated with a user, the profile indicating one or more data types and at least one profile-specific format associated with each data type of the one or more data types;
determining, based on access of a document by the user and the profile associated with the user, an input field of the document that requires a format different from a profile-specific format associated with a data type of the profile, wherein the input field corresponds to the data type of the profile;
causing a modified input field corresponding to the profile-specific format to be presented in a modified view over the input field of the document;
subsequent to obtaining a user input related to the input field, updating the modified input field such that the modified input field depicts the user input in the profile-specific format associated with the data type; and
providing, to the input field, the user input in the format required for the input field while the modified input field corresponding to the profile-specific format is presented in the modified view.

4. The method of claim 3, further comprising:
transforming the user input into the format required for the input field,
wherein providing the user input comprises providing the transformed user input to the input field while the modified input field corresponding to the profile-specific format is presented in the modified view.

5. The method of claim 3, wherein the modified input field visually replaces the input field in the modified view.

6. The method of claim 3, further comprising:
defining the input field as a hidden input field in the modified view in connection with causing the modified input field to be presented in the modified view.

7. The method of claim 3, wherein the modified view comprises the input field and the modified input field as part of a form, the method further comprising:
in response to a user submission of the form, transmitting, to a recipient associated with the form, the user input in the format required for the input field as a value for the input field without transmitting the user input in the profile-specific format to the recipient.

8. The method of claim 3, further comprising:
determining, based on the access of a document by the user and the profile associated with the user, a second input field of the document that corresponds to a language different from a profile-specific language of the profile;
causing a second modified input field corresponding to the profile-specific language to be presented in the modified view over the second input field of the document;
subsequent to obtaining a second user input in the profile-specific language, updating the second modified input field such that the second modified input field depicts the second user input in the profile-specific language of the profile; and
providing, to the second input field, the second user input in the language to which the second input field corresponds while the second modified input field corresponding to the profile-specific format is presented in the modified view.

9. The method of claim 8, wherein the modified view comprises, as part of a form, the input field, the modified input field, the second input field, and the second modified input field, the method further comprising:
in response to a user submission of the form, transmitting, to a recipient associated with the form, (i) the user input in the format required for the input field as a value for the input field and (ii) the second user input in the language to which the second input field corresponds, without transmitting the user input in the profile-specific format to the recipient and without transmitting the second user input in the profile-specific language to the recipient.

10. The method of claim 3, wherein the modified view is an augmented reality view.

11. One or more non-transitory computer-readable media comprising instructions that, when executed by one or more processors, cause operations comprising:
obtaining a profile associated with a user, the profile indicating one or more data types and at least one profile-specific format associated with each data type of the one or more data types;
parsing a document to identify text portions of the document that correspond to at least one data type of the profile associated with the user;
determining, based on the parsing and the profile associated with the user, a text portion of the document that is in a format different from a profile-specific format associated with a data type of the profile, wherein the text portion corresponds to the data type of the profile; and
causing a modified text portion corresponding to the profile-specific format to be presented in a modified view over the text portion of the document.

12. The media of claim 11, the operations further comprising:
subsequent to obtaining a user input related to the text portion, updating the modified text portion such that the modified text portion depicts the user input in the profile-specific format associated with the data type; and
providing, to the text portion, the user input in the format of the text portion while the modified text portion corresponding to the profile-specific format is presented in the modified view.

13. The media of claim 12, the operations further comprising:
transforming the user input into the format of the text portion,
wherein providing the user input comprises providing the transformed user input to the text portion while the modified text portion corresponding to the profile-specific format is presented in the modified view.

14. The media of claim 12, wherein the modified view comprises the text portion and the modified text portion as part of a form, the operations further comprising:
in response to a user submission of the form, transmitting, to a recipient associated with the form, the user input in the format of the text portion as a value for the text portion without transmitting the user input in the profile-specific format to the recipient.

15. The media of claim 12, the operations further comprising:
determining, based on the access of a document by the user and the profile associated with the user, a second text portion of the document that corresponds to a language different from a profile-specific language of the profile;
causing a second modified text portion corresponding to the profile-specific language to be presented in the modified view over the second text portion of the document;
subsequent to obtaining a second user input in the profile-specific language, updating the second modified text portion such that the second modified text portion depicts the second user input in the profile-specific language of the profile; and
providing, to the second text portion, the second user input in the language to which the second text portion corresponds while the second modified text portion corresponding to the profile-specific format is presented in the modified view.

16. The media of claim 15, wherein the modified view comprises, as part of a form, the text portion, the modified text portion, the second text portion, and the second modified text portion, the media further comprising:
in response to a user submission of the form, transmitting, to a recipient associated with the form, (i) the user input in the format of the text portion as a value for the text portion and (ii) the second user input in the language to which the second text portion corresponds, without transmitting the user input in the profile-specific format to the recipient and without transmitting the second user input in the profile-specific language to the recipient.

17. The media of claim 15, the operations further comprising:
defining the second text portion as a hidden text portion in the modified view in connection with causing the second modified text portion to be presented in the modified view such that the second modified text portion visually replaces the second text portion in the modified view.

18. The media of claim 11, wherein the modified text portion visually replaces the text portion in the modified view.

19. The media of claim 11, the operations further comprising:
defining the text portion as a hidden text portion in the modified view in connection with causing the modified text portion to be presented in the modified view.

20. The media of claim 11, wherein the modified view is an augmented reality view.
